(19) United States
(12) Patent Application Publication
(10) Pub. No.: US 2013/0239188 A1
(43) Pub. Date: Sep. 12, 2013

(54) Authentication Method for a Universal Serial Bus Device and Related Universal Serial Bus Device

(71) Applicant: Helen Meng Pai, Taipei City (TW)

(72) Inventor: Helen Meng Pai, Taipei City (TW)

(73) Assignee: AUTHENEX ASIA INC., Taipei City (TW)

(21) Appl. No.: 13/463,759

(22) Filed: May 3, 2012

(30) Foreign Application Priority Data
Mar. 12, 2012 (TW) 101108309

(51) Int. Cl. G06F 21/00; G06F 15/16

(52) U.S. Cl. 726/6

(57) ABSTRACT

The present invention discloses an authentication method for a Universal Serial Bus (USB) device. The authentication method includes performing two-way authentication with an authentication server via a server, to generate an authentication result indicating whether the authentication is successful; and generating a one time password according to the authentication result.

### BACKGROUND OF THE INVENTION

1. Field of the Invention

The present invention relates to an authentication method for a Universal Serial Bus (USB) device and related USB device, and more particularly, to an authentication method for an USB device capable of reducing cost and increasing security and related USB device.

2. Description of the Prior Art

In the network, normal data transmission, authentication or software generally use methods or devices such as accounts, passwords or tokens to determine whether a user is authorized. The user can ask the token company for a hardware device of a token and can initialize and set protections of a specific account via specific websites. Each time the user wants to access the protected account, software or specific server (ex. log in a specific domain or an account of specific on-line store), the user has to enter an account and a password first, and then inserts the token to the user computer for authenticating whether the account, the password and the token are correct. If the account, the password and the token are correct, the user can use the software, the account or the data.

Generally, whether the authentication passes is decided by the server in the above authentication method. However, the above authentication method still has risk. For example, the user may unconsciously connect to a fake website. After the user enters the one-time password displayed by the token, the fake website performs re-login to the real website, which results risk. Besides, the conventional toke generally uses a liquid crystal display for displaying the one-time password to allow the user to enter the one time password, which results higher cost and inconvenience. Thus, there is a need to improve the prior art.

### SUMMARY OF THE INVENTION

Therefore, the goal of the present invention is providing an authentication method capable of reducing cost and increasing security for a USB device and related USB device.

The present invention discloses an authentication method for a Universal Serial Bus (USB) device. The authentication method includes performing two-way authentication with an authentication server via a server, to generate an authentication result indicating whether the authentication is successful; and generating a one time password according to the authentication result.

The present invention further discloses a Universal Serial Bus (USB) device. The USB device includes a transmitting unit, for transmitting messages of performing two-way authentication with an authentication sever to a server; a receiving unit, for receiving messages of performing the two-way authentication with the authentication sever and an authentication result; a determining unit, for determining whether received messages of authentication and verification are correct; and a password generating unit, for generating a one time password according to the authentication result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an authentication method according to an embodiment of the present invention.

FIG. 2 is a schematic diagram of a token according to an embodiment of the present invention.

### DETAILED DESCRIPTION

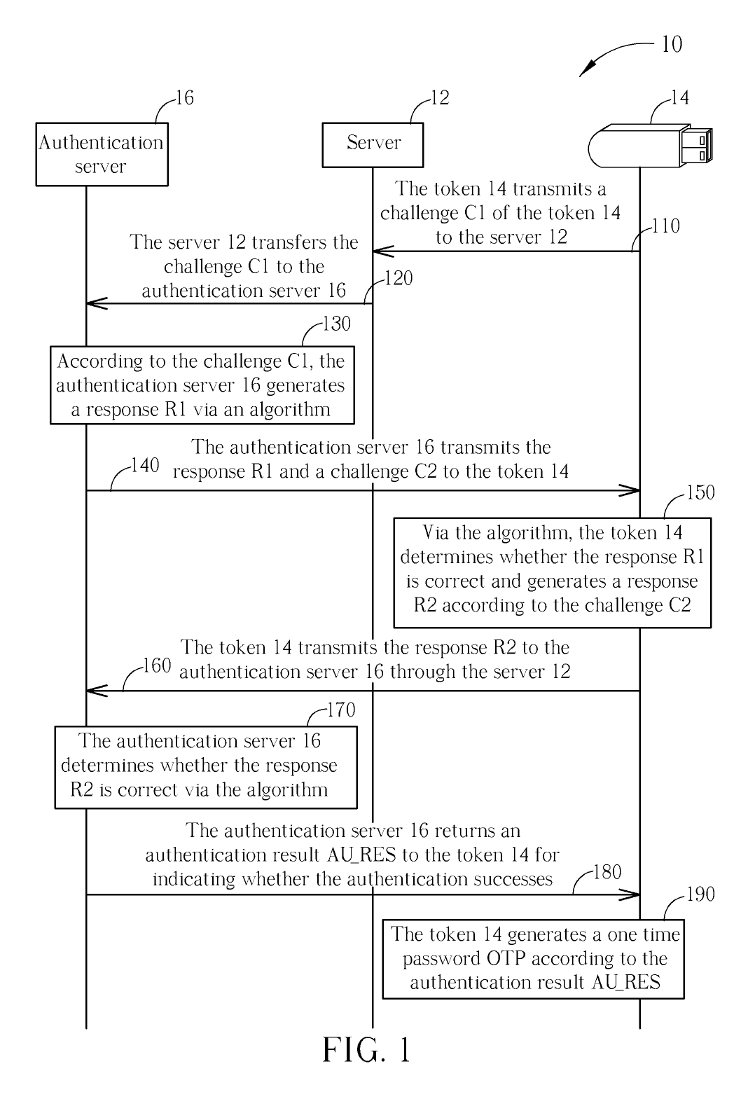

Please refer to FIG. 1, which is a schematic diagram of an authentication method 10 according to an embodiment of the present invention. The authentication method 10 is utilized for implementing an authentication between a server 12 and an authentication server 16 thereof and a Universal Serial Bus (USB) device 14, such as a token 14. The server 12 maybe a network server and the token 14 can connect to the server 12 via a user computer used by the user. The step of the authentication method 10 comprises:

Step 110: The token 14 transmits a challenge C1 of the token 14 to the server 12.

Step 120: The server 12 transfers the challenge C1 to the authentication server 16.

Step 130: According to the challenge C1, the authentication server 16 generates a response R1 via an algorithm.

Step 140: The authentication server 16 transmits the response R1 and a challenge C2 to the token 14.

Step 150: Via the algorithm, the token 14 determines whether the response R1 is correct and generates a response R2 according to the challenge C2.

Step 160: The token 14 transmits the response R2 to the authentication server 16 through the server 12.

Step 170: The authentication server 16 determines whether the response R2 is correct via the algorithm.

Step 180: The authentication server 16 returns an authentication result AU_RES to the token 14 for indicating whether the authentication successes.

Step 190: The token 14 generates a one time password OTP according to the authentication result AU_RES.

According to the authentication method 10, the token 14 performs a two-way authentication with the authentication server 16 through the server 12, to generate the authentication result AU_RES for indicating whether the two-way authentication successes. The token 14 then generates the one time password OTP according to the authentication result AU_RES.

In detail, the token 14 transmits the challenge C1 to the server 12 and the server 12 transfers the challenge C1 to the authentication server 16, i.e. the server 12 helps the authentication server 16 to receive the message from the token 14. The authentication server 16 then uses the algorithm for generating the response R1 according to the challenge C1, and transmits the response R1 and the challenge C2 to the token 14. Next, the token 14 determines whether the response R1 is correct via the algorithm (i.e. the token 14 compares the response R1 with a result acquired by calculating the challenge C1 via the algorithm) . Via the algorithm, the token 14 generates the response R2 according to the challenge C2, and transmits the responses R2 to the authentication server 16 through the sever 12. Finally, the authentication server 16 uses the algorithm to determine whether the response R2 is correct, i.e. the authentication server 16 compares the response R2 and a result acquired by calculating the challenge C2 via the algorithm. The authentication server 16 then transmits the authentication result AU_RES to the token 14 for indicating whether the authentication successes, such that the toke 14 generates the one-time password OTP according to the authentication result AU_RES. Therefore, if the authentication result AU_RES indicates the authentication fails, the server currently logged in is not an authorized server and the token does not generate the one-time password OTP. If the authentication result AU_RES indicates the authentication successes, the token 14 generates the one-time password OTP according to the operation of the user. Note that, since the token 14 performs the two-way authentication with the authentication server 16 through the server 12, the server 12 is an authorized server when the authentication result AU_RES indicates the authentication successes (a server which is not authorized can not transfer the message from the token 14 to the authentication server 16 for the two-way authentication).

In such a condition, the token 14 may comprise at least one light for displaying the authentication status, ex. blue light for indicating the authentication successes and twinkling blue light for indicating the authentication is under execution. Instead of entering the one-time password OTP by the user, the user can trigger a switch of the token 14 when the light indicates the authentication successes, such that the token 14 directly transmits the one-time password OTP to the server 12. The server 12 then transfers the one-time password OTP to the authentication server 16 for performing the authentication. When the authentication server 16 determines the one-time password OTP is correct, the authentication server 16 indicates the server 12 for granting the user to log in. The switch of the token 14 can be a touch-control switch which is triggered by touching the switch, but the switch of the token 14 can also be other kinds of switch such as a mechanical switch or a button switch, and is not limited herein.

In other words, the token 14 transmits the challenge C1 to the authentication sever 16 through the server 12, such that the authentication server 16 generates the corresponding response R1 according to the challenge C1 and returns the response R1 to the token 14 for performing authentication. The token 14 then generates the corresponding response R2 according to the challenge C2 and transmits the response R2 to the authentication server 16 through the server 12 for performing authentication, to generate the authentication result AU_RES. When the authentication successes, the user can trigger the switch of the token 14 for directly transmitting the one-time password OTP to the server 12, and then the one-time password is transferred to the authentication server 16 through the server 12. As a result, the user can successfully log in the target such as domain or website instead of unconsciously transmitting the one-time password OTP to the fake website (the fake website can not transfer the message from the toke 14 to the authentication server 16 for the two-way authentication with, and thus the two-way authentication can not be successfully performed).

As can be seen from the above, in the authentication method 10, the token 14 performs two times authentication processes of the challenge/response procedures with the authentication server 16 via the server 12. The token 14 transmits the one-time password OTP to the server 12 for performing login after determining the authentication successes, and thus the one-time password OTP would not be unconsciously transmitted to the fake website. As a result, the token 14 of the present invention can perform two-way authentication with the authentication server 16 via the server 12 for determining whether the server 12 is the correct website. The security is therefore increased. Furthermore, the user can directly transmit the one-time password OTP, which is generated when the authentication successes, to the server 12 by triggering the switch of the token 14, such that the server 12 transfers the one-time password OTP to the authentication server 16 for performing authentication. In addition to increasing the convenience, the token 14 does not need the liquid crystal display for displaying the one-time password OTP and the cost can be therefore reduced.

Besides, before the user uses the token 14 to perform the above operations, the user can install software in the user computer. After the user inserts the token 14 to the user computer, the software would ask the user to enter a password as an examination password and an address of a server which the user wants to log in, the software then checks whether the sever exists. Next, the user has to enter the examination password for examination each time the user uses the token 14. After the examination is achieved, the user can then perform the above operations. Furthermore, when the token 14 is inserted in the user computer and the user has not entered the password for examination, the light can be red light for indicating the user is under examination. After the user pass the examination, the light can be twinkling blue light for indicating the authentication is under execution.

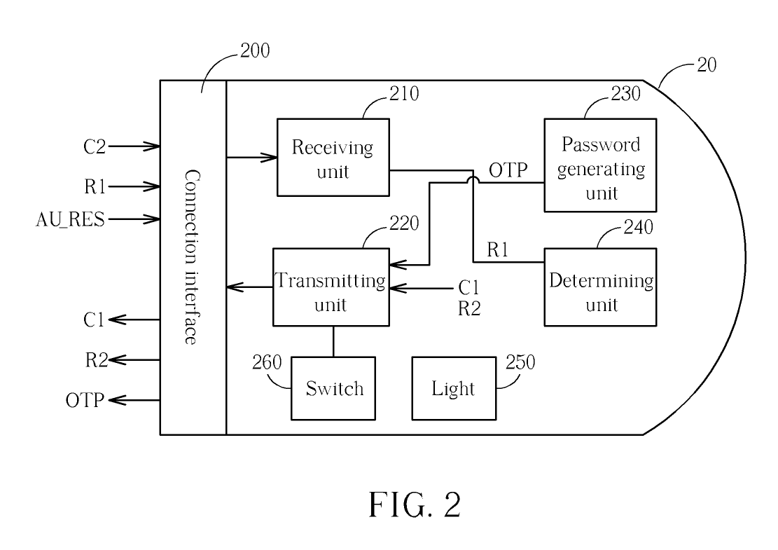

Please refer to FIG. 2, which is a schematic diagram of a token 20 according to an embodiment of the present invention. The token 20 is utilized for implementing the token 14 of the authentication method 10, and comprises a connection interface 200, a receiving unit 210, a transmitting unit 220, a password generating unit 230, a determining unit 240, a light 250 and a switch 260. Via the connection interface 200, the receiving unit 210 and the transmitting unit 220 exchange signals with a server (ex. the server 12 shown in FIG. 1) through a user computer. The connection interface 200 can be an interface such as a Universal Serial Bus (USB), a Line Print Terminal (LPT), a RS-232, etc., such that the token 20 can use the same communications protocol or the same transmission data encoding method of the user computer for exchanging data with the server through the user computer. When the transmitting unit 220 transmits the challenge C1 to an authentication server through the connection interface 200 and the server, the authentication server generates the corresponding response R1 according to the challenge C1 and transmits the response R1 to the token 20 for performing authentication. Next, when the receiving unit 210 receives the response R1, the determining unit 240 can use the algorithm to determine whether the response R1 is correct. The transmitting unit 220 then transmits the corresponding response R2 to the authentication server according to the challenge C2, which is received by the receiving unit 210, for performing authentication. The authentication server accordingly returns the authentication result AU_RES. When the authentication result AU_RES indicates the authentication successes, the password generating unit 230 generates the one-time password OTP according to operations of the user and the light 250 shows the authentication successes in a certain manner. The user then triggers the switch 260 for directly transmitting the one-time password OTP generated by the password generating unit 230 to the server. Since the token 20 can be used to implement the token 14 of the authentication method 10, the detailed authentication procedures can be referred to FIG. 1 and are not described herein for brevity.

In the prior art, the user may unconsciously connect to the fake website, and enter the one-time password. The fake website then performs re-login to the real website with the one-time password, which results risk. In addition, the conventional token generally uses the liquid crystal display for displaying the one-time password and then the user enters the one time password, which results higher cost due to liquid crystal display and inconvenience. In comparison, the token of the present invention can perform the two-way authentication with the authentication server through the server for determining whether the server is the correct website. The security is therefore increased. Besides, the user can directly transmit the one-time password, which is generated when the authentication successes, to the sever by triggering the switch of the token, such that the server transfers the one-time password to the authentication server for performing authentication. In addition to increasing convenience, the cost is reduced since the token of the present invention does not need the liquid crystal display to show the one-time password.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An authentication method for a Universal Serial Bus (USB) device, comprising:
performing two-way authentication with an authentication server via a server, to generate an authentication result indicating whether the authentication is successful; and
generating a one time password according to the authentication result.

2. The authentication method of claim 1, wherein the server is a granted logging host when the authentication result indicates the server is correct.

3. The authentication method of claim 1, further comprising:
triggering a switch of the USB device when the authentication result indicates the server is correct, to generate and transmit the one time password to the server.

4. The authentication method of claim 3, wherein the server transfers the one time password to the authentication server for performing authentication.

5. The authentication method of claim 3, wherein the switch is a touch-control switch and the step of triggering the switch of the USB device comprises touching the switch.

6. The authentication method of claim 1, further comprising utilizing at least one light for displaying an authentication status.

7. A Universal Serial Bus (USB) device, comprising:
a transmitting unit, for transmitting messages of performing two-way authentication with an authentication sever to a server;
a receiving unit, for receiving messages of performing the two-way authentication with the authentication sever and an authentication result;
a determining unit, for determining whether received messages of authentication and verification are correct; and
a password generating unit, for generating a one time password according to the authentication result.

8. The USB device of claim 7, wherein the server is a granted logging host when the authentication result indicates the server is correct.

9. The USB device of claim 7, further comprising a switch for receiving a trigger when the authentication result indicates the server is correct, such that the transmitting unit transmits the one time password to the server.

10. The USB device of claim 9, wherein the server transfers the one time password to the authentication server for performing authentication.

11. The USB device of claim 9, wherein the switch is a touch-control switch and is triggered by touching the switch.

12. The USB device of claim 7, further comprising at least one light for displaying an authentication status.
